(19) United States
(12) Patent Application Publication
(10) Pub. No.: US 2024/0331343 A1
(43) Pub. Date: Oct. 3, 2024

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: Yasuo Suzuki, Kanagawa (JP)

(21) Appl. No.: 18/738,679

(22) Filed: Jun. 10, 2024

Related U.S. Application Data
(63) Continuation of application No. PCT/JP2022/043669, filed on Nov. 28, 2022.

(30) Foreign Application Priority Data
Dec. 28, 2021 (JP) 2021-215138

(51) Int. Cl. G06V 10/26; G06V 40/20

(52) U.S. Cl. CPC G06V 10/26; G06V 40/20

(57) ABSTRACT

An image processing apparatus obtains an image shot such that a court of a sporting event is within an angle of view, detects a plurality of objects in the image, trims an area specified based on positions of the plurality of objects in the image, and recognizes an action of a specific player out of the plurality of objects based on a trimmed image. The apparatus trims an area including the specific player specified based on a reference being a position of a first object used in the sporting event out of the plurality of objects.

### CROSS-REFERENCE TO RELATED APPLICATIONS

This application is a Continuation of International Patent Application No. PCT/JP2022/043669, filed Nov. 28, 2022, which claims the benefit of Japanese Patent Application No. 2021-215138 filed Dec. 28, 2021, both of which are hereby incorporated by reference herein in their entirety.

### BACKGROUND OF THE INVENTION

### Field of the Invention

The present invention relates to an image processing apparatus, an image processing method, and a storage media.

### Background Art

A technology for recognizing an action of a player in a shot image of a sporting event has been conventionally known. PTL 1 proposes a technology of detecting players based on features of face parts such as a pupil and a nose in a shot moving image of a volleyball game, and recognizing a player hitting a serve based on the positions and attitudes of players in a court and whether or not each player is carrying a ball. PTL 2 proposes a technology of recognizing a mountain climbing course from a shot image of a sport climbing competition through machine learning, and thereafter analyzing an action of a competitor by estimating competitors on the course and the skeleton of each competitor.

### CITATION LIST

### Patent Literature

PTL1: International Publication No. 2019/235350
PTL2: Japanese Patent Laid-Open No. 2021-26292

In order to detect each player moving on the court in the image, it is desirable to shoot an image of the entire court in an overhead view. Meanwhile, in inference processing in machine learning, low-resolution images are commonly input to prevent an increase in processing load. When machine learning is applied to a shot image of an entire court of volleyball or the like, the image may not contain sufficient pixel information for recognizing the face and a movement, and an appropriate recognition result may not be obtained. Further, in many cases, a player whose action is to be recognized cannot be specified by determining the position of the player in the court in advance, depending on the sporting event. That is, a player whose action needs to be recognized, of a plurality of players in the shot image of the entire court, also needs to be determined regardless of the position of the player in the image. PTLs 1 and 2 above do not consider such issues.

### SUMMARY OF THE INVENTION

The present invention has been made in view of the foregoing issues and aims to realize a technology that enables an action of a player to be appropriately recognized even in the case of using a shot image in which a court is within the angle of view.

To solve the above issues, for example, an image processing apparatus of the present invention has the following configuration. That is, the image processing apparatus includes: obtaining means for obtaining an image shot such that a court of a sporting event is within an angle of view, detection means for detecting a plurality of objects in the image, trimming means for trimming an area specified based on positions of the plurality of objects in the image; and recognition means for recognizing an action of a specific player out of the plurality of objects based on a trimmed image, wherein the trimming means trims an area including the specific player specified based on a reference being a position of a first object used in the sporting event out of the plurality of objects.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a block diagram showing an example of a system configuration of Embodiment 1.

FIG. 2A is a block diagram showing an example of a hardware configuration of a learning server and an image processing apparatus of Embodiment 1.

FIG. 2B is a sequence diagram of data transmission/reception and processing performed by apparatuses in an image processing system of Embodiment 1.

FIG. 2C-1 is a flowchart of operation of the image processing apparatus in the image processing system of Embodiment 1.

FIG. 2C-2 is a flowchart of operation of a data collection server in the image processing system of Embodiment 1.

FIG. 2C-3 is a flowchart of operation of the learning server in the image processing system of Embodiment 1.

FIG. 2D is a conceptual diagram showing a structure of input and output to/from a learning model of Embodiment 1.

FIG. 3 is a block diagram showing an example of a configuration of the image processing apparatus of Embodiment 1.

FIG. 4 is a diagram illustrating an object to be shot in Embodiment 1.

FIG. 5 is a diagram illustrating an example of an overhead image of Embodiment 1.

FIG. 6 is a diagram for illustrating an object detection unit of Embodiment 1.

FIG. 7 is a diagram (1) for illustrating a specific-player detection unit of Embodiment 1.

FIG. 8 is a diagram (2) for illustrating the specific-player detection unit of Embodiment 1.

FIG. 9 is a diagram (1) for illustrating a trimming-coordinate determination unit of Embodiment 1.

FIG. 10 is a diagram (2) for illustrating the trimming-coordinate determination unit of Embodiment 1.

FIG. 11 is a diagram illustrating a case of applying the present embodiment to another sport.

FIG. 12 is a block diagram showing an example of a configuration of an image processing apparatus of Embodiment 2.

FIG. 13 is a diagram illustrating an overlapping-player detection unit of Embodiment 2.

### DESCRIPTION OF THE EMBODIMENTS

### Embodiment 1

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### <Configuration of Image Processing System>

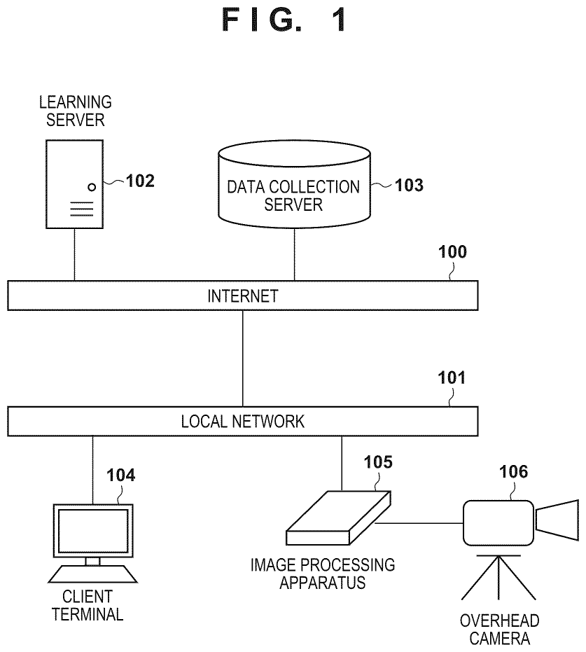

An example of an image processing system according to the present embodiment will be described with reference to FIG. 1. The image processing system includes, for example, the internet 100, a local network 101, a learning server 102, a data collection server 103, a client terminal 104, an image processing apparatus 105, and an overhead camera 106.

The Internet 100 and the local network 101 are networks connecting devices in the image processing system. Either one of the networks may be used if the devices can be connected through the network. The learning server 102 is, for example, a server computer as an example of an information processing apparatus and performs processing at a learning stage of later-described machine learning to obtain parameters of a trained model. The data collection server 103 is, for example, a server computer as an example of an information processing apparatus. Training data used in the processing at the learning stage is accumulated in the data collection server 103, which provides the training data to the learning server 102. The client terminal 104 is an example of a communication device and starts data transmission and reception between the devices in the system. The overhead camera 106 is an image capture device such as a digital camera, for example, and outputs a later-described overhead image. The image processing apparatus 105 is, for example, a personal computer and performs inference processing or the like of later-described machine learning on a moving image shot by the overhead camera 106.

### <Configuration of Learning Server and Image Processing Apparatus>

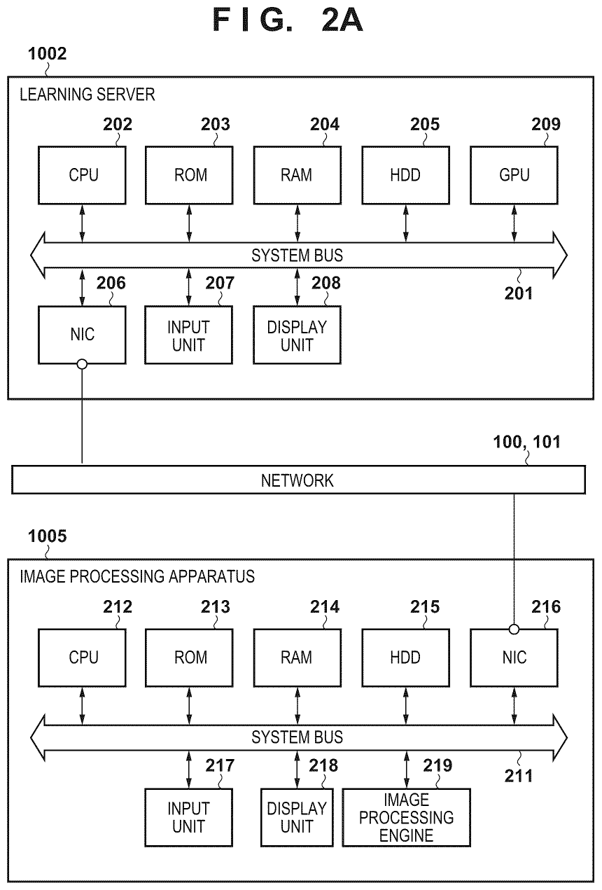

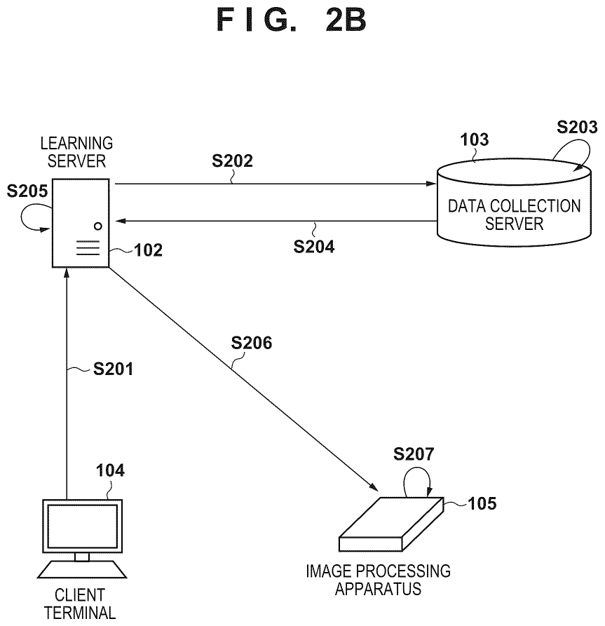

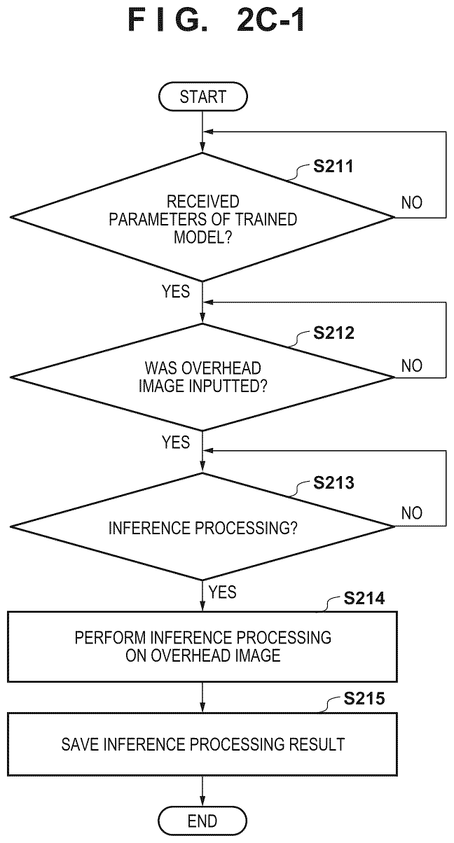

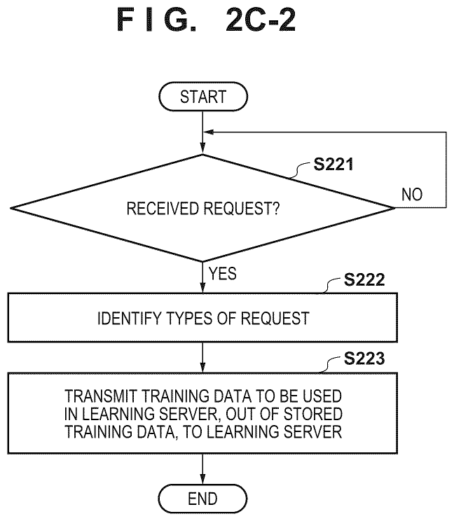

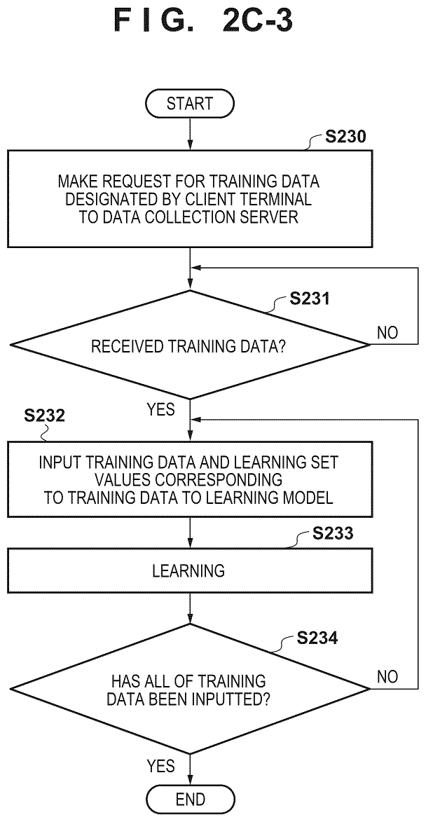

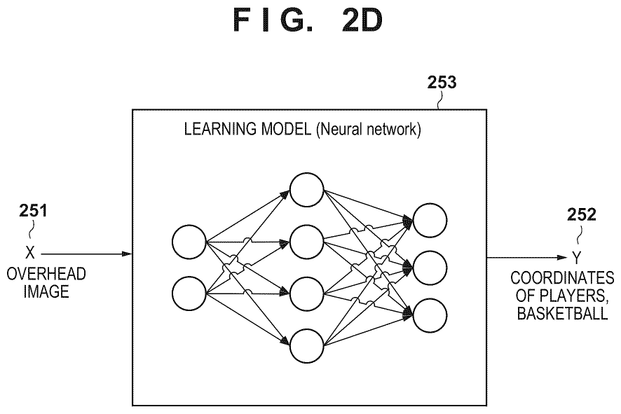

FIG. 2A shows an example of a hardware configuration of the learning server 102 and the image processing apparatus 105 in the image processing system according to the present embodiment.

The learning server 102 includes, for example, a CPU 202, a ROM 203, a RAM 204, an HDD 205, an NIC 206, an input unit 207, a display unit 208, and a GPU 209. The CPU 202 is an arithmetic circuit such as a CPU (Central Processing Unit) and realizes each function of the learning server 102 by loading a program stored in the ROM 203 or the HDD 205 to the RAM 204 and executing the loaded program. The ROM 203 includes, for example, a nonvolatile storage medium such as a semiconductor memory, and stores, for example, programs to be executed by the CPU 202 and necessary data. The RAM 204 includes, for example, a volatile storage medium such as a semiconductor memory, and temporarily stores, for example, results of calculation performed by the CPU 202 or the like. The HDD 205 includes a hard disk drive and stores, for example, programs to be executed by the CPU 202 and training data of the present embodiment. The GPU (Graphics Processing Unit) 209 includes an arithmetic circuit, and may execute, for example, a part or all of the calculation for training the learning model. The NIC 206 includes a network interface for performing communication via a network (e.g. the Internet 100 and/or the local network 101). The input unit 207 includes, for example, a keyboard or the like for receiving operation input made by an administrator of the learning server 102, or an interface for connecting the keyboard or the like, but need not necessarily be included in the learning server 102. The display unit 208 includes a display, for example, and displays, for example, a user interface for the administrator of the learning server 102 to check the operating state of the learning server 102 and operate the learning server 102, but need not necessarily be included in the learning server 102.

For example, the CPU 202 loads, to the RAM 204, a learning program stored in the HDD 205 and the ROM 203, and the training data stored in the HDD 205. Next, the CPU 202 executes the program loaded to the RAM 204 and trains the learning model using the training data. Processing for training the learning model may alternatively be executed by the GPU 209 in accordance with an instruction given by the CPU 202.

The image processing apparatus 105 includes, for example, a CPU 212, a ROM 213, a RAM 214, an HDD 215, an NIC 216, an input unit 217, a display unit 218, and an image processing engine 219. The CPU 212 is an arithmetic circuit such as a CPU (Central Processing Unit) and realizes each function of the image processing apparatus 105 by loading a program stored in the ROM 213 or the HDD 215 to the RAM 214 and executing the loaded program. The ROM 213 includes, for example, a nonvolatile storage medium such as a semiconductor memory and stores, for example, programs to be executed by the CPU 212 and necessary data. The RAM 214 includes, for example, a volatile storage medium such as a semiconductor memory, and temporarily stores, for example, results of calculation performed by the CPU 212 or the like. The HDD 215 includes a hard disk drive and stores, for example, processing results of programs executed by the CPU 212. The NIC 216 includes a network interface for performing communication via a network (e.g. the Internet 100 and/or the local network 101). The input unit 217 includes, for example, a keyboard or the like for receiving operation input made to the image processing apparatus 105 or an interface for connecting the keyboard or the like. The display unit 218 includes a display, for example, and displays, for example, a user interface for checking the operating state of the image processing apparatus 105 and operating the image processing apparatus 105. The image processing engine 219 is, for example, an image processing circuit that performs predetermined processing (e.g. reduction processing) on an input image.

The image processing apparatus 105 may be connected to a second camera separate from the overhead camera (not shown) directly or via a network and control shooting with the second camera using the CPU 212, for example. The second camera is a camera that performs shooting with a narrower angle of view than that of the overhead camera and shoots a part of the court. For example, the second camera can shoot an enlarged image of a player whose action has been recognized through later-described action recognition processing. For example, if the image processing apparatus 105 recognizes that the player is performing a specific action based on a later-described action recognition result, the image processing apparatus 105 may control swing and zooming of the second camera to shoot the action of the player. The second camera can thus shoot an image of a specific player as a main subject in response to the action of the specific player.

### <Player Action Recognition Processing Performed by Image Processing Apparatus>

Next, a description is given of processing (which will be referred to as “player action recognition processing”) performed by the image processing apparatus to recognize an action of a player from an overhead image obtained by shooting a sporting event. The player action recognition processing is realized by, for example, the CPU 212 of the image processing apparatus 105 executing a program.

The following description takes, as an example of the player action recognition processing, a case of recognizing an action of a specific basketball player from an overhead image obtained by shooting a basketball court. However, the player action recognition processing can also be applied to action recognition in other sporting events in which a plurality of players play a game in a field for the competition. For example, the player action recognition processing can also be applied to recognition of an action of a player in other sporting events such as soccer, rugby, and volleyball. In this case, the fields for the competitions are courts for soccer, rugby, volleyball, and so on.

In the player action recognition processing according to the present embodiment, later-described object detection processing and action recognition processing is performed using respective learning models. Each learning model is subjected to processing at the learning stage in the learning server 102 and performs processing at the inference stage using learned parameters in the image processing apparatus 105. First, a description is given of the processing at the learning stage performed by the learning server 102 in the image processing system, and then a description is given of a configuration for realizing the player action recognition processing performed by the image processing apparatus 105.

### <Operation of Devices in Image Processing System>

A sequence of data transmission/reception and processing performed by the devices in the image processing system is described with reference to FIG. 2B.

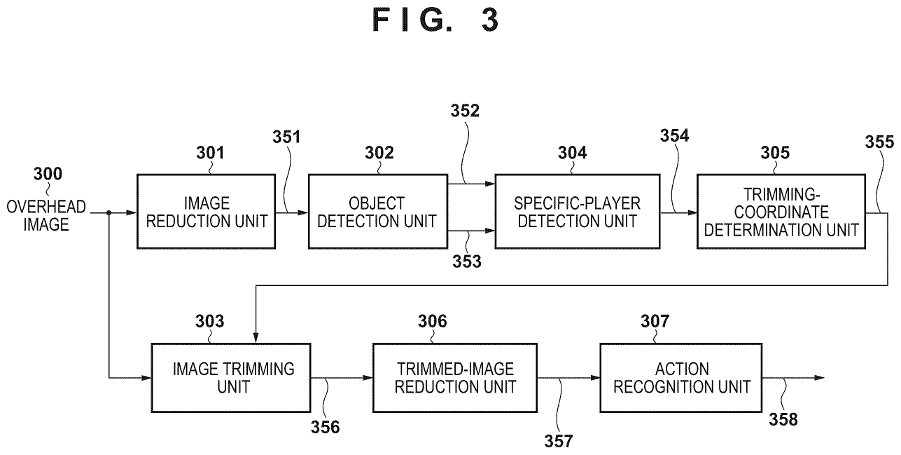

Note that the following is a description of the image processing system taking an example of training a learning model for object detection that is used in the player action recognition processing. Here, in the description with reference to FIGS. 2B, 2C, and 2D, an image simply referred to as an “overhead image” for simplifying the explanation indicates an overhead image reduced so as to have the same number of pixels as a reduced image signal 351 (a reduced overhead image) shown in FIG. 3, which will be described later.

In S201, the client terminal 104 gives the learning server 102 an instruction to obtain training data. Note that the training data for object detection according to the present embodiment may be, for example, a set of data including an overhead image, basketball players in the overhead image, and values of ball coordinates. In S202, the learning server 102 makes a request for the training data to the data collection server 103. For example, the learning server 102 may make a request for training data by designating information indicating a type of the training data. In S203, the data collection server 103 extracts the requested training data from the storage unit and transmits the extracted training data to the learning server. In S205, after receiving the training data, the learning server 102 performs processing at the learning stage of machine learning and obtains parameters of the trained model (by calculation). In S206, the learning server 102 transmits the obtained parameters of the trained model to the image processing apparatus 105. In S207, the image processing apparatus 105 performs processing at the inference stage of the learning model (e.g. object detection on a newly shot overhead image) using the parameters of the trained model received from the learning server 102.

### <Operation of Data Collection Server>

Next, operation of the data collection server 103 is described with reference to FIG. 2C-2. Although the subject of the operation is the data collection server in the description with reference to in FIG. 2C-2, each operation is realized by a CPU (not shown) of the data collection server executing a program.

In S221, the data collection server 103 receives a request for training data from the learning server 102. Next, in S222, the data collection server 103 identifies the types of the requested training data. In the example of the present embodiment, the types of training data are an overhead image, and values of the coordinates of players and a basketball. In S223, the data collection server 103 transmits training data to be used in the learning server 102, out of the stored training data, to the learning server 102.

### <Operation of Learning Server>

Next, operation of the learning server 102 is described with reference to FIG. 2C-3. In the learning performed by the learning server 102, training data (e.g. an overhead image) is input to a learning model 503, which is constituted by a neural network schematically shown in FIG. 2D. In the case of a learning model for object detection, for example, the learning model 503 outputs the coordinates of the players and the basketball in the overhead image as the results of calculation performed on the overhead image.

In this learning processing, the GPU 209 is used in addition to the CPU 202 of the learning server 102. That is, when a learning program involving the learning model is executed, the CPU 202 and the GPU 209 cooperatively perform calculation to perform learning. Since the GPU 209 can perform efficient calculation by performing parallel processing on more data, it is effective to perform processing with the GPU 209 in deep learning in which repeated calculation is performed using a learning model. Note that in the processing at the learning stage, calculation may be performed only by either the CPU 202 or the GPU 209. Thus, although the subject of the operation is the learning server in the description with reference to FIG. 2C-3, each operation is realized by at least either the CPU 202 or the GPU 209 executing the program.

In S230, the learning server 102 makes a request for training data designated by the client terminal to the data collection server 103. In S231, the learning server 102 determines whether or not the training data has been received from the data collection server 103. If it is determined that the training data has been received from the data collection server 103, the learning server 102 advances the processing to S232. If not, the learning server 102 returns to S231 and repeats the processing.

In S232, the learning server 102 inputs the training data received from the data collection server and learning set values corresponding to the training data to the learning model. Here, the learning model is the aforementioned learning model 503. The learning set values in the present embodiment are, for example, parameter values of data augmentation to be applied to the input signal to the learning model 503.

In S233, the learning server 102 executes processing for training the learning model 503. In S234, the learning server 102 determines whether or not all of the training data has been input. If all of the training data has been input, the processing ends, and if not, the learning server 102 returns to S232 and repeats the processing. Note that determination as to whether or not to end the learning in S234 is an example. All of the training data may be repeatedly input a predetermined number of times, or the processing may end in response to the value of a loss function satisfying a predetermined condition. The learning server 102 obtains parameters of the trained model (a combined weighting coefficient of the trained neural network etc.) by completing the training.

The learning processing in S234 includes error detection processing and update processing. In the error detection processing, the learning server calculates, for example, an error between output data (the coordinates of the players and the basketball) output from an output layer of the neural network in accordance with the overhead image input to an input layer, and the coordinates of the players and the basketball included in the training data. Here, the coordinates of the players and the basketball included in the training data are given in advance in the overhead image and are so-called correct labels. In the error detection processing, a difference between the output data from the neural network and the training data may be calculated by using a loss function. In the update processing, the learning server updates combined weighting coefficients or the like between nodes of the neural network so as to reduce the error obtained through the error detection processing, based on the error. In this update processing, for example, the combined weighting coefficients or the like are updated using an error backpropagation method. The error backpropagation method is a method for adjusting combined weighting coefficients or the like between nodes of each neural network so as to reduce the aforementioned error.

### <Inference Processing Performed by Image Processing Apparatus>

Next, operation of inference processing performed by the image processing apparatus 105 is described with reference to FIGS. 2C-1. The image processing apparatus 105 performs processing at the inference stage of machine learning using a program stored in the HDD 215 or the ROM 213 and the parameters of the trained model (received from the learning server and) stored in the HDD 215. That is, the CPU 212 of the image processing apparatus 105 performs inference processing on a newly shot overhead image using the parameters of the trained model and the program. As mentioned above, an image simply referred to as an “overhead image” for simplification of the description with reference to FIG. 2C-1 corresponds to the reduced image signal 351 obtained by reducing the overhead image in the configuration shown in FIG. 3. The subject of the operation is the image processing apparatus in the description, but each operation is realized by the CPU 212 executing the program.

In S211, the image processing apparatus 105 determines whether or not the parameters of the trained model have been received from the learning server 102. If the parameters of the trained model have not been received, the processing returns to S211, and if received, the processing advances to S212. In S212, the image processing apparatus 105 determines whether or not the overhead image has been obtained. If not, the processing returns to S212, and if obtained, the processing advances to S213. In S213, the image processing apparatus 105 determines whether or not an instruction to start inference processing has been received from a user. If not, the processing returns to S213, and if received, the processing advances to S214. In S214, the image processing apparatus 105 inputs the obtained overhead image to the learning model and performs inference processing. In S215, the image processing apparatus 105 stores the coordinate positions of the players and the ball, which are the inference results, in an HDD 215. The image processing apparatus 105 then ends the processing.

### <Configuration for Player Action Recognition>

Next, a configuration for player action recognition is described with reference to FIG. 3. The configuration shown in FIG. 3 is, for example, a software configuration (which is also referred to as “player action recognition module”) realized by the CPU 212 of the image processing apparatus 105 executing a program. The player action recognition module includes, for example, an image reduction unit 301, an object detection unit 302, an image trimming unit 303, a specific-player detection unit 304, a trimming-coordinate determination unit 305, a trimmed-image reduction unit 306, and an action recognition unit 307.

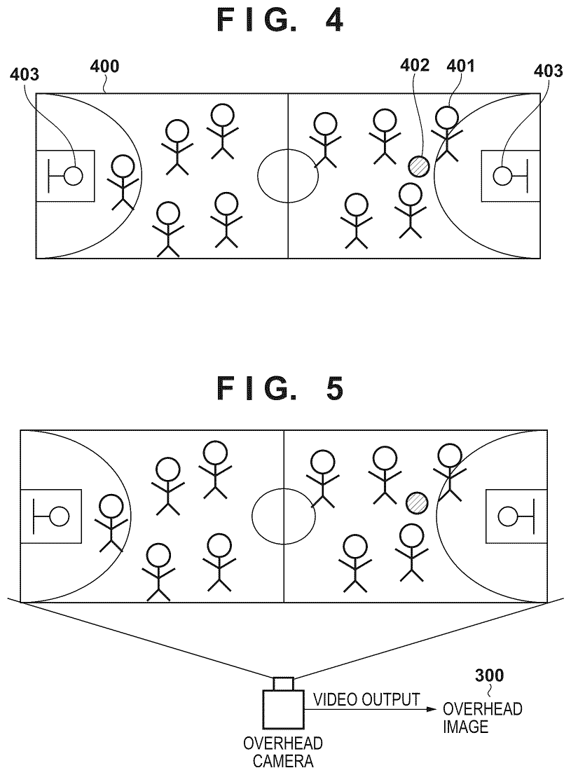

An image input to the player action recognition module is, for example, an image (overhead image 300) obtained by shooting an entire basketball court shown in FIG. 4. For example, players 401, a basketball 402, a goal ring 403, and so on, are present in a basketball court 400. For example, the overhead camera 106 shoots an image such that the basketball court is within the angle of view (such that no part of the court is out of the angle of view) as shown in FIG. 5, and outputs the shot overhead image 300. Note that the overhead camera 106 outputs the shot image of the entire basketball court as a moving image or a still image.

The shot image includes, for example, 3840 pixels in the horizontal direction and 2160 pixels in the vertical direction, but the number of pixels is not limited thereto and may be any other number of pixels. The image is output from the overhead camera 106 in a format conforming to HDMI (High-Definition Multimedia Interface) (registered trademark), SDI (Serial Digital Interface), or the like, for example. Note that the overhead image 300 may alternatively be an image that is temporarily recorded in a recording medium (not shown) in the overhead camera and then read (exported).

The image reduction unit 301 reduces the overhead image 300 to an image suitable for subsequent processing performed by the object detection unit 302. As mentioned above, the overhead image 300 includes, for example, 3840 pixels in the horizontal direction and 2160 pixels in the vertical direction. If this overhead image 300 is input as-is to the object detection unit 302, a large processing load is placed on the object detection unit 302 due to the large number of pixels. The image reduction unit 301 thus converts the overhead image 300 by reducing the number of pixels of the overhead image 300 from 3840 pixels in the horizontal direction and 2160 pixels in the vertical direction to 400 pixels in the horizontal direction and 400 pixels in the vertical direction, and outputs the resulting image as a reduced image signal 351. Here, the number of pixels of the reduced image signal 351 is not limited to the above and may be set as appropriate in accordance with the processing capability of the object detection unit 302.

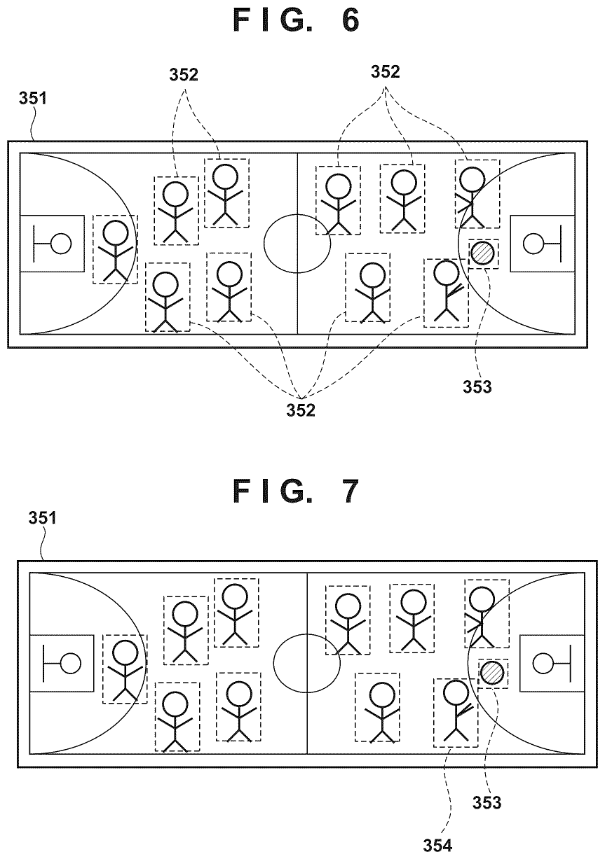

As shown in FIG. 6, the object detection unit 302 detects the players and the basketball in the basketball court from the reduced image signal 351. The object detection unit 302 performs, for example, processing at the inference stage using the deep neural network trained by the aforementioned learning server 102 and detects the players and the basketball (outputs player coordinates 352 and ball coordinates 353 of the basketball in the image). The deep neural network has been trained to detect the whole body of each player, rather than a specific part of the body of the player. That is, each player is detected in the mode of an entire image of the body of the player.

Coordinate values of a plurality of players are detected and output as multiple-player coordinates 352 from the object detection unit 302. The coordinate values of the ball are output as ball coordinates 353 from the object detection unit 302. The coordinate values of each of the players and the ball may be, for example, upper left, lower left, upper right, and lower left coordinate values of a rectangle. Note that the description of the present embodiment is given by taking an example of detecting a basketball and players in a basketball game; meanwhile, in the case of ice hockey, a pack may be detected instead of a ball.

Note that the description of the present embodiment is given by taking an example of using deep learning for adjusting the features and combined weighting coefficients for learning by itself by means of a neural network. However, as a specific algorithm of machine learning, a nearest neighbor method, a naive Bayesian method, a decision tree, a support vector machine or the like that can be used may be applied, as appropriate, to the present embodiment. The results of detecting the players or the like through the processing at the inference stage may be represented by rectangular coordinate values, as shown in FIG. 6.

As is apparent from the above description, the object detection unit 302 detects the ball and the players by performing processing with the deep neural network to which an image having a smaller number of pixels than the overhead image 300 is input. The amount of calculation is thus smaller than that in the case of using a deep neural network to which the overhead image 300 is input, and detection processing can be performed at a higher speed or in a more power-saving manner.

The specific-player detection unit 304 outputs specific the specific-player coordinates 354 based on the multiple-player coordinates 352 and the ball coordinates 353. The specific-player coordinates 354 are determined in accordance with the positional relationship between the ball coordinates 353 and the multiple-player coordinates 352. For example, the specific-player detection unit 304 first determines the center position of the coordinates of each of the ball and the players, based on the ball coordinate 353 and the multiple-player coordinates 352. For example, when the upper left coordinate values are (100,100), the lower left coordinate values are (100,300), the upper right coordinate values are (300,100), and the lower right coordinate values are (300,300), the center position of the coordinates is represented as (200,200).

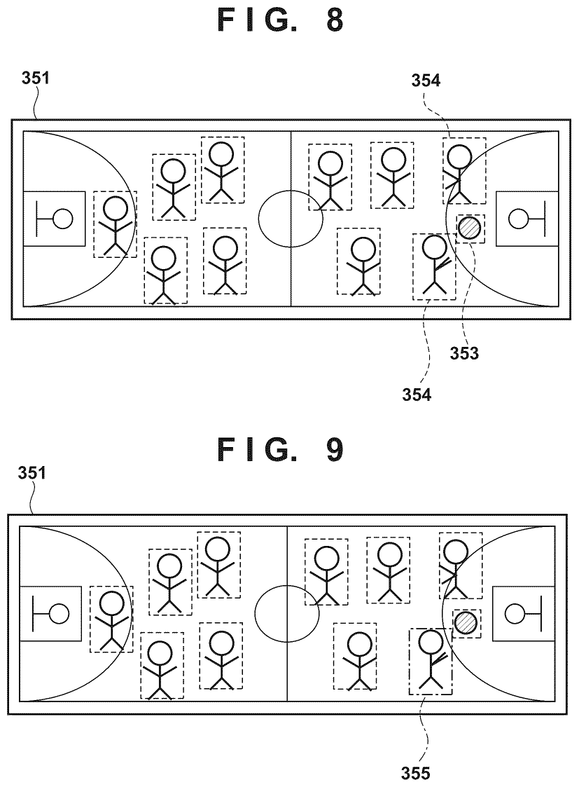

Next, the specific-player detection unit 304 detects the center position of at least one pair of the multiple-player coordinates that is closest to the center position of the ball coordinates. Here, “being closest” means that the distance between the center positions is shortest. In the example shown in FIG. 7, the specific-player coordinates 354 are the coordinates of a player closest to the center position of the ball coordinates 353 out of the plurality of players. Note that the method of detecting the specific-player coordinates 354 is not limited to the above, and at least one pair of the multiple-player coordinates that is close to (within a predetermined distance from) the center position of the ball coordinates 353 may be detected. Specifically, the specific-player coordinates 354 are the coordinates of one of the plurality of players within the predetermined distance from the center position of the ball coordinates 353, as shown in FIG. 8.

The trimming-coordinate determination unit 305 determines image trimming coordinates based on the specific-player coordinates 354 and outputs the determined coordinates as trimming coordinates 355. If there is only one pair of the specific-player coordinates 354 as shown in FIG. 7, the same coordinate values as those of the specific-player coordinates 354 are output as the trimming coordinates 355 as shown in FIG. 9.

If there are two or more pairs of specific-player coordinates 354 as shown in FIG. 7, the trimming-coordinate determination unit 305 determines rectangular coordinates that include the plurality of pairs of specific-player coordinates 354 as shown in FIG. 10 and outputs the determined rectangular coordinates as the trimming coordinates 355. Note that the trimming coordinates 355 may be the upper left, lower left, upper right, and lower right coordinate values of the rectangle (i.e. to represent the trimming area of the image).

The image trimming unit 303 determines a trimmed image 356 based on the overhead image 300 and the trimming coordinates 355. An image indicated by the coordinate values corresponding to the trimming coordinates 355 is trimmed from the overhead image 300.

The trimmed-image reduction unit 306 reduces the trimmed image 356 to an image suitable for subsequent processing performed by the action recognition unit 307. The number of pixels of the trimmed image 356 varies depending on the trimming coordinates 355. The rectangle of the trimming coordinates 355 may be large if, for example, there are two or more pairs of specific-player coordinates 354 as shown in FIG. 10. In this case, the number of pixels of the trimmed image 356 is large. Here, a large number of pixels of the trimmed image 356 increases the processing load placed on the action recognition unit 307. The trimmed-image reduction unit 306 thus reduces the image to be input to the action recognition unit 307.

If, for example, the trimmed image 356 includes 500 pixels in the horizontal direction and 300 pixels in the vertical direction, the trimmed-image reduction unit 306 converts the image by reducing the trimmed image 356 to an image of 200 pixels in the horizontal direction and 200 pixels in the vertical direction, and output the converted image as a reduced trimmed image 357. Note that the reduced image size is not limited to the above and can be determined based on the processing capability of the action recognition unit 307.

The action recognition unit 307 recognizes an action of a player based on the reduced trimmed image 357 and outputs the recognized action as an action recognition result 358. Actions recognized by the action recognition unit 307 include, for example, actions performed by a player in a basketball game, such as a shot, a pass, and a dribble. The action recognition performed by the action recognition unit 307 may be detected through deep learning, for example. In the present embodiment, for example, the learning server 102 trains the learning model to recognize a shot, a pass, and a dribble of the basketball player. The action recognition unit 307 performs inference processing with the learning model using the parameters of the trained model received from the learning server 102, for example. The action recognition unit 307 recognizes an action of the specific player by receiving the input of the reduced trimmed image 357.

The action recognition unit 307 may recognize the action of the player based on spatial features of one reduced trimmed image 357. In this case, the action recognition unit 307 recognizes the action of the player using a deep neural network configured to recognize the action based on the spatial features, for example. The action recognition unit 307 may be configured to recognize the action of the player based also on time-series features using a time-series reduced trimmed image 357 corresponding to each frame of the moving image. In this case, the action recognition unit 307 may recognize the action of the player using a deep neural network configured to recognize the action based on the time-series features. The action recognition unit 307 outputs the result of recognizing the action of the player as the action recognition result 358.

As is apparent from the above description, the action recognition unit 307 recognizes the action of the specific player by performing processing with a deep neural network that receives input of an image having a smaller number of pixels than that of the overhead image. The calculation amount is therefore smaller than that in the case of using a deep neural network that receives input of the overhead image 300, so that the action recognition processing can be performed at a higher speed or in a more power-saving manner.

The player action recognition processing of the present embodiment can also be applied to sports other than basketball, as mentioned above. Now a case is considered where the above player action recognition processing is applied to soccer, for example. When determining a plurality of players at a distance close to the ball center position as the specific-player coordinates 354, players at a closer distance than in the case of basketball are detected.

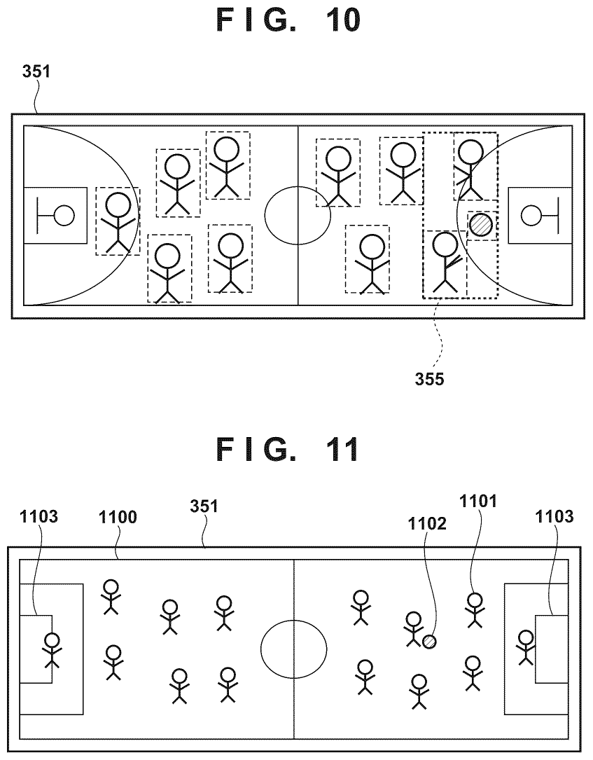

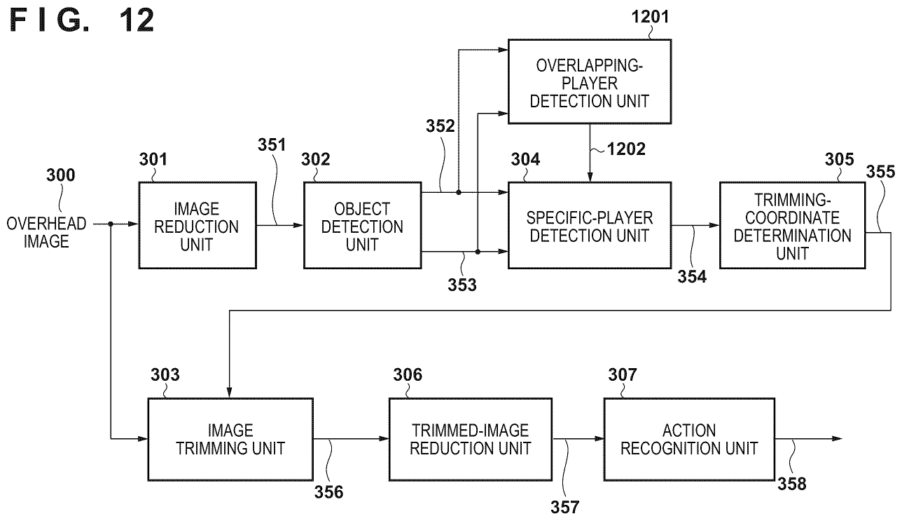

In the case where the reduced image signal 351 indicates a shot image of an entire soccer court 1100 as shown in FIG. 11, a soccer court is larger than a basketball court, and the sizes of players and a soccer ball are thus relatively small. That is, in the reduced image signal 351, the length of the actual distance corresponding to one pixel is larger than that in the case of basketball, and it is thus necessary to detect a player closer to the ball than in the case of basketball. The distance between each player and the ball in the image when specifying the specific player may thus be set to a different value in accordance with the ratio of the size of the court to the size of the player, for example. In the case of adapting the above embodiment to soccer, the action recognition unit 307 recognizes actions of a soccer player, such as a shot, a pass, and heading.

If, for example, the object detection unit 302 discontinues detection of the players and the ball in the middle (e.g. fails in the detection in a specific frame), the coordinate values in the frame in which last detection was successful (i.e. the coordinate values that were successfully detected immediately previously) may be used. This is because there are cases where the detection of both the players and the ball fails when the players overlap each other or when the ball is hidden behind a player.

As described above, in the present embodiment, an image shot such that a court of a sporting event is within the angle of view is obtained, a plurality of objects (players and a ball etc.) are detected in the image, and an area specified based on the positions of these objects in the image is trimmed. When trimming the image, an area including a specific player specified based on the position of an object (a ball, a pack etc.) used in the competition is trimmed. Then, an action of the specific player is recognized based on the trimmed image. The action of the player can thus be appropriately recognized even in the case of using a shot image in which the court is within the angle of view.

### Embodiment 2

In Embodiment 2, a description is given of a method of detecting an overlap between multiple-player coordinates and ball coordinates and determining a specific player. In the present embodiment, the configuration of a part (overlapping-player detection unit) of the player action recognition module is different from Embodiment 1, but the other configuration is substantially the same as Embodiment 1. Thus, substantially the same constituents are given the same reference numerals, and redundant description is omitted. The description focuses on differences.

### (Configuration for Player Action Recognition)

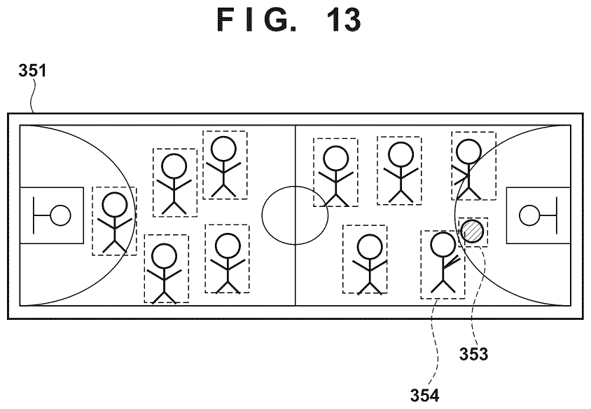

A configuration for player action recognition of Embodiment 2 is described with reference to FIG. 12. The configuration shown in FIG. 12 is a software configuration realized by the CPU 212 of the image processing apparatus 105 executing a program, as in Embodiment 1. The configuration shown in FIG. 12 includes an image reduction unit 301, an object detection unit 302, an image trimming unit 303, a specific-player detection unit 304, a trimming-coordinate determination unit 305, a trimmed-image reduction unit 306, an action recognition unit 307, and an overlapping-player detection unit 1201. Of these, the constituents other than the overlapping-player detection unit 1201 are substantially the same as those of the Embodiment 1.

The overlapping-player detection unit 1201 outputs overlapping coordinates 1202 based on the multiple-player coordinates 352 and the ball coordinates 353 output from the object detection unit 302.

First, the overlapping-player detection unit 1201 detects whether or not rectangles of the multiple-player coordinates 352 and the ball coordinates 353 overlap each other. For example, FIG. 13 shows a case where the rectangles of the multiple-player coordinates 352 and the ball coordinates 353 overlap each other. If it is determined that the rectangles of the multiple-player coordinates 352 and the ball coordinates 353 overlap each other, the overlapping-player detection unit 1201 outputs the coordinate values of the overlapping player as overlapping coordinates 1202. Here, if there are two or more rectangles of the player coordinates 352 overlapping the rectangle of the ball coordinates 353, the overlapping-player detection unit 1201 outputs the coordinate values of the player having the highest degree of overlapping with the rectangle of the ball coordinates 353 as the overlapping coordinates 1202. On the other hand, if there is no rectangle of the player coordinates 352 overlapping the rectangle of the ball coordinates 353, information indicating no coordinate value is output from the overlapping coordinate 1202.

The specific-player detection unit 304 determines the specific-player coordinates 354 based on the multiple-player coordinates 352, the ball coordinates 353, and the overlapping coordinates 1202. If player coordinate values have been input as the overlapping coordinate 1202, the specific-player detection unit 304 outputs, as the specific-player coordinates 354, only the player coordinate values indicated as the overlapping coordinates 1202. If information indicating no coordinate value is input as the overlapping coordinates 1202, the specific-player detection unit 304 performs the same operation as in Embodiment 1. That is, the specific-player detection unit 304 outputs the coordinate values of the player closest to (or within a predetermined distance from) the center position of the ball coordinates 353 as the specific-player coordinates 354. Thus, the player closer to the ball can be specified even when players are gathering at a place on the court, and the player whose action is to be recognized can be favorably trimmed. Consequently, the action of a player can be appropriately recognized even when using a shot image in which the court is within the angle of view.

According to the present invention, it is possible to enable an action of a player to be appropriately recognized even in the case of using a shot image in which a court is within in the angle of view.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An image processing apparatus comprising:
an obtaining unit configured to obtain an image shot such that a court of a sporting event is within an angle of view,
a detection unit configured to detect a plurality of objects in the image,
a trimming unit configured to trim an area specified based on positions of the plurality of objects in the image; and
a recognition unit configured to recognize an action of a specific player out of the plurality of objects based on a trimmed image,
wherein the trimming unit trims an area including the specific player specified based on a reference being a position of a first object used in the sporting event out of the plurality of objects.

2. The image processing apparatus according to claim 1,
wherein the trimming unit trims an area including the specific player being a player at a position within a predetermined distance from the position of the first object.

3. The image processing apparatus according to claim 2,
wherein the trimming unit trims an area including the specific player being a player at a position closest to the position of the first object.

4. The image processing apparatus according to claim 1,
wherein in a case where a rectangle detected as a player overlaps a rectangle detected as the first object, the player is specified as the specific player, and the trimming unit trims an area including the specific player.

5. The image processing apparatus according to claim 2,
wherein the predetermined distance varies in accordance with a ratio between a size of the court of the sporting event and a size of the player.

6. The image processing apparatus according to claim 1, further comprising
a first reduction unit configured to reducing the image obtained by the obtaining unit,
wherein the detection unit detects the plurality of objects in the image using the reduced image.

7. The image processing apparatus according to claim 1, further comprising:
a second reduction unit configured to reducing the image trimmed by the trimming unit,
wherein the recognition unit recognizes the action of the specific player using the trimmed and reduced image.

8. The image processing apparatus according to claim 1,
wherein the recognition unit recognizes the action of the specific player by performing processing with a learning model to which an image having a smaller number of pixels than that of the image obtained by the obtaining unit is input.

9. The image processing apparatus according to claim 1,
wherein the detection unit detects the plurality of objects by performing processing with a learning model to which an image having a smaller number of pixels than that of the image obtained by the obtaining unit is input.

10. The image processing apparatus according to claim 1, further comprising:
a control unit configured to controlling zooming of a second camera for shooting an image of a part of the court, the second camera being different from a first camera for shooting an image in which the court is within the angle of view,
wherein the control unit controls the second camera so as to shoot an enlarged image of the specific player performing a predetermined action in response to the recognition unit recognizing the predetermined action.

11. The image processing apparatus according to claim 1,
wherein the trimming unit trims an image including the specific player being at least one player.

12. An image processing method comprising:
obtaining an image shot such that a court of a sporting event is within an angle of view;
detecting a plurality of objects in the image;
trimming an area specified based on positions of the plurality of objects in the image; and
recognizing an action of a specific player out of the plurality of objects based on the trimmed image,
wherein an area is trimmed that includes the specific player specified based on a reference being a position of a first object used in the sporting event out of the plurality of objects.

13. A non-transitory computer-readable storage medium storing instructions for performing an image processing method, the method comprising:
obtaining an image shot such that a court of a sporting event is within an angle of view;
detecting a plurality of objects in the image;
trimming an area specified based on positions of the plurality of objects in the image; and
recognizing an action of a specific player out of the plurality of objects based on the trimmed image,
wherein an area is trimmed that includes the specific player specified based on a reference being a position of a first object used in the sporting event out of the plurality of objects.
